(19) United States
(12) Patent Application Publication
(10) Pub. No.: US 2024/0378375 A1
(43) Pub. Date: Nov. 14, 2024

(54) Generation of Structured Content Using a Collaborative Online Generator

(71) Applicant: Google LLC, Mountain View, CA (US)

(72) Inventors: Killian Robert Coate, New York, NY (US); Alexander Burmistrov, Jersey City, NJ (US); Aliya Aliya, Scarsdale, NY (US); Dmitriy Brezhnev, New York, NY (US); Elliott Malkin, Clinton Corners, NY (US); Gaye Oncul Kok, Kirkland, WA (US); Kester Christopher Tong, New York, NY (US); Lauren Nicole DeNaut, New York, NY (US); Shira Gilboa, Stamford, CT (US); Aleksandr Sinayev, New York, NY (US); Victoria Mary Taylor, New York, NY (US); Julian Martin Eisenschlos, Zürich (CH); Chenxi Pang, Zürich (CH)

(21) Appl. No.: 18/650,501

(22) Filed: Apr. 30, 2024

Related U.S. Application Data
(60) Provisional application No. 63/501,066, filed on May 9, 2023.

(51) Int. Cl. G06F 40/18; G06F 40/40; G06N 3/0475; G06N 3/08

(52) U.S. Cl. CPC G06F 40/18; G06F 40/40; G06N 3/0475; G06N 3/08

(57) ABSTRACT

Systems and methods for generating structured content using a collaborative generator provide a user interface to a user computing system and receive a prompt from the user computing system via the user interface, the prompt including existing content within an integrated development environment. The systems and methods provide the prompt to a generative model, with the generative model being a machine-learned model trained to process language input prompts to generate a language output. The systems and methods receive a generative output generated by the generative model in response to the prompt, the generative output including generative content divided into one or more generative content cells. Additionally, the systems and methods provide the generative output via the user interface.

### PRIORITY CLAIM

The present application is based on, and claims benefit of priority to, U.S. Provisional Application 63/501,066 having a filing date of May 9, 2023, which is incorporated by reference herein in its entirety.

### FIELD

The present disclosure relates generally to online generators, such as online artificial intelligence programs used to generate document content using generative models. More particularly, the present disclosure relates to generating structured content collaboratively using such online generators.

### BACKGROUND

Online generators are often used to create document content, such as for articles, letters, essays, and/or the like, using large language models. However, such generators are outside of documents or environments intended to be filled with the generated content, such as cell-based environments. As such, a user must copy the generated content from the generator over to the intended environment into separate cells and format the generated content within the intended environment to match existing or desired formatting within the environment. Further, such generators only allow for set or pre-defined actions regarding editing the content generated. As such, a user has limited options for requesting edits from such generators, which often leads to a user needing to perform significant editing after generation. Additionally, existing generators lack the ability to evaluate a table. Thus, a user must manually input prompts from each cell into the generators and paste the generative content for each into a table, which is time consuming.

Accordingly, systems and methods for generating structured content using a collaborative online generator would be beneficial in the technology.

### SUMMARY

Aspects and advantages of embodiments of the present disclosure will be set forth in part in the following description, or can be learned from the description, or can be learned through practice of the embodiments.

One example aspect of the present subject matter is directed to a computing system for automatically generating structured content. The computing system may include one or more processors, and one or more non-transitory computer-readable media that collectively store instructions that, when executed by the one or more processors, cause the computing system to perform operations. The operations performed may include providing a user interface to a user computing system and receiving a prompt from the user computing system via the user interface, where the prompt may include existing content within an integrated development environment. The operations performed may further include providing the prompt to a generative model, with the generative model being a machine-learned model trained to process language input prompts to generate an output. Moreover, the operations performed may include receiving a generative output generated by the generative model in response to the prompt, with the generative output including generative content divided into one or more generative content cells.

In some implementations, the operations include providing the generative output generated by the generative model via the user interface. The operations can, in some instances, further include receiving an insertion request from the user computing system via the user interface subsequent to providing the generative output. In one instance, providing the user interface includes providing an integrated development environment in which content is insertable in-line, where the generative output is provided in a generative area of the integrated development environment, with the generative area separating the generative output from being in-line within the integrated development environment, and where the generative output is provided via the user interface by inserting the generative output in-line within the integrated development environment after receiving the insertion request.

In certain example aspects, the existing content may be within a first series of content cells of a grid within the integrated development environment and the generative content cells comprises a second series of content cells, where the generative content within each of the second series of content cells may be associated with the existing content within a respective one of the first series of content cells. In one aspect, the generative content within each of the second series of content cells includes a respective smart chip defined based at least in part on the existing content within the respective one of the first series of content cells. In some aspects, providing the generative output may include replacing the first series of content cells with the second series of content cells. In certain aspects, the existing content within the first series of content cells comprises only unpaired inputs. In some aspects, the prompt further includes a natural language processing instruction request. For instance, in some aspects, the natural language processing instruction requests may include generating the generative content by at least one of classifying, extracting, summarizing, or standardizing the existing content or suggesting additional content based at least in part on the existing content. However, in some instances, the existing content within the first series of content cells may include one or more unpaired inputs and at least one pair of input and solution, where the generative content within each of the second series of content cells may include a respective solution for pairing with the unpaired input within the respective one of the first series of content cells.

Another example aspect of the present subject matter is directed to a computer-implemented method for automatically generating structured content. The method may include providing, by a computing system including one or more processors, a user interface to a user computing system. The method may further include receiving, by the computing system, a prompt from the user computing system via the user interface, where the prompt may include existing content within an integrated development environment. Further, the method may include providing, by the computing system, the prompt to a generative model, the generative model being a machine-learned model trained to process language input prompts to generate an output. Furthermore, the method may include receiving, by the computing system, a generative output generated by the generative model in response to the prompt, where the generative output may include generative content divided into one or more generative content cells. Moreover, the method may include providing, by the computing system, the generative output via the user interface.

An additional example aspect of the present subject matter is directed to one or more non-transitory computer-readable media that collectively store instructions that, when executed by one or more computing devices, cause the one or more computing devices to perform operations. The operations can include providing a user interface to a user computing system, receiving a prompt from the user computing system via the user interface, where the prompt may include existing content within an integrated development environment, and providing the prompt to a generative model, the generative model being a machine-learned model trained to process language input prompts to generate an output. The operations can further include receiving a generative output generated by the generative model in response to the prompt, the generative output including generative content divided into one or more generative content cells. Additionally, the operations can include providing the generative output via the user interface.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that generates structured content using generative models according to example embodiments of the present disclosure.

FIG. 1B depicts a block diagram of an example computing device that generates structured content using generative models according to example embodiments of the present disclosure.

FIG. 1C depicts a block diagram of an example computing device that generates structured content using generative models according to example embodiments of the present disclosure.

FIG. 2 depicts a block diagram of an example of structured content generation using generative models according to example embodiments of the present disclosure.

FIG. 3 depicts an illustration of an example interface for interacting with a generative model for generating generative output content within a collaborative, integrated development environment according to example embodiments of the present disclosure;

FIG. 4 depicts an illustration of an example interface interaction for providing a prompt to a generative model for generating generative output content and receiving a generative output from such generative model in response to the prompt according to example embodiments of the present disclosure;

FIG. 5 depicts an illustration of an example interface for requesting recreation by a generative model of a generative output generated by the generative model according to example embodiments of the present disclosure;

FIG. 6 depicts an illustration of an example interface interaction for providing an updated prompt to a generative model for generating generative output content and receiving the generative output from such generative model in response to the updated prompt according to example embodiments of the present disclosure;

FIG. 7 depicts an illustration of an example interface for providing a generative output in response to a prompt to a generative model for generating output content and providing an example generative output to be inserted within the integrated development environment according to example embodiments of the present disclosure, particularly where the generative output is separate of in-line content before insertion;

FIG. 8 depicts an illustration of example interfaces for providing a generative output in response to a prompt to a generative model for generating output content and providing an example modified output inserted in-line within the integrated development environment according to example embodiments of the present disclosure;

FIGS. 9-12 depict illustrations of further example interfaces for providing a prompt to a generative model for generating generative output content and providing an example generative output according to example embodiments of the present disclosure, particularly where the prompt includes unpaired inputs and the generative output content includes outputs for the unpaired inputs;

FIGS. 13 and 14 depict illustrations of example interfaces for providing a prompt to a generative model for generating generative output content and providing a generative output in response to a prompt to a generative model for generating generative output content, respectively, where the generative output includes one or more smart chips according to example embodiments of the present disclosure; and

FIG. 15 depicts a flow chart diagram of an example method to generate structured content using generative models according to example embodiments of the present disclosure.

Reference numerals that are repeated across plural figures are intended to identify the same features in various implementations.

### DETAILED DESCRIPTION

### Overview

Generally, the present disclosure is directed to systems and methods for generating structured content using generative models (e.g., large language models) in response to prompts. More particularly, the systems and methods disclosed herein optimize and automate aspects of insertion of generative content generated by generative models into integrated development environments, particularly into cell-based integrated development environments or other integrated development environments with cells or tables. As an example, a computing system can obtain a prompt. The prompt can be processed with a machine-learned generative model to generate generative content based on the prompt. For instance, the prompt may include processing instructions requesting a trip plan, information summary chart, and/or the like directed to a specific topic and/or including specific details (e.g., as defined/requested in the prompt). In some instances, the prompt may include existing content within the integrated development environment (e.g., existing content within cells) and, optionally, processing instruction requests for generating the generative content based on the existing content (e.g., to classify the existing content, extract information from the existing content, summarize the existing content, standardize the existing content, suggest additional content based at least in part on the existing content, and/or the like). The generative output content generated by the generative model may include language content (e.g., text, code, and/or the like) automatically separated into cells.

For example, if the prompt includes a natural language prompt such as “Plan a solo trip to Iceland for seven full days that includes hiking” and/or selection of existing content related to a trip to Iceland (e.g., a title or cell within the integrated development environment propagated with “Iceland trip”), the generative output may include a structured table including information about a trip to Iceland (e.g., information within columns for different itinerary days, activities for each itinerary day, a description of the activity, a location for the activity, the expected duration for the activity, the cost of the activity, and the level of difficulty for the activity, etc.) and/or the like associated with the prompt.

If the existing content includes unpaired inputs within the integrated development environment, the generative output may include outputs or solutions to pair with the unpaired inputs. For example, if the existing content includes unpaired input cells related to different customer service questions (e.g., “Can I make a tablet return?”, “I'd like to cancel please,” and/or the like) the generative model may provide an output cell corresponding to each unpaired input with content classifying the customer service questions (e.g., “Return,” “Cancel,” and/or the like). In such instances, the generative model may be able to identify the most likely desired output (e.g., based on historical data or training examples) without further input. In some instances, however, the existing content may include one or more pairs of input/output that serve as context or processing instruction requests in the prompt for the generative model and/or the prompt may include natural language provided in addition to the existing content to serve as processing instructions for the generative model.

If the existing content includes existing content that the generative model may make “smart,” the generative output may include “smart chip” replacements for replacing such existing content. For instance, if the existing content in the prompt includes a list of email addresses, the generative output may include smart chips linking a name associated with each email address to the email address, or providing smart chips with a blank name field for the computing system to populate linked to the email address, where the blank fields (if present) may be populated outside of the model using user data and the generative output will replace the existing content upon insertion. Similarly, if the existing content in the prompt includes a list of items that use a list of categories (e.g., “low,” “medium,” and “high”; “started,” “not started,” “done,” “blocked”; “1,” “2,” “3”; etc.), the generative content will generate a smart drop-down list with the categories and select the most appropriate category from the drop-down for each of the list of items, where the drop-down selections will replace the existing content. Other examples of smart chip replacements include check-box lists (e.g., to replace “yes” and “no”), website or file explorer address linking, and/or the like.

The generative output may be separated from in-line content within the integrated development environment. For instance, the generative output may be provided in a separate pane within the integrated development environment or may be overlaid on (but not inserted into) the integrated development environment (e.g., floating over cells of the integrated development environment in which the generative content is to be inserted). As such, a user may request that the model refine the generative output content (e.g., remove columns rows), regenerate the generative output content (e.g., resubmit the prompt to the model for new generative output content), and/or adjust the prompt and request an updated generative output based on the adjusted, updated prompt before insertion of the generative output content in-line within the integrated development environment. When the generative output content is approved to be inserted into the development environment, the computing system may insert the generative output content in-line into the development environment.

In some instances, the generative model may not have proper formatting information to format the generative output content to match the desired end location (e.g., development environment). Thus, in some implementations, the computing system may be configured to automatically modify the generative output content to match the formatting rules of the development environment when the generative output content is approved to be inserted into the development environment. In one implementation, the prompt may include embedded formatting rules (e.g., cell size, text wrapping, font style, font size, etc.), which may be passed along with the generative output content to the computing system for the computing system to modify the generative output content to correspond to the formatting rules upon insertion. In some implementations, the generative model may parse the generative content to identify different content levels (e.g., title, heading, subheading, body, etc.) within the generative content such that the computing system may more easily format the generative content according to the formatting rules. However, in other instances, the computing system may parse the generative content to identify or suggest formatting rules for different content levels. In such fashion, the computing system can facilitate interactions between the user and the machine-learned large language model to deliver and format generated content to the user within the development environment.

Aspects of the present disclosure provide a number of technical effects and benefits. As one example technical effect and benefit, users of conventional generative models, separate of development environments (e.g., word processing applications, applications with word processing (e.g., a spreadsheet program), etc.) often must spend substantial quantities of time and effort navigating between the generative models and the development environment to generate generative content using the generative models, inserting the generative content into the development environment within the structured format, and making the generative content smarter (e.g., manually generating smart links), etc. However, by optimizing interactions between users, machine-learned large language models, and development environments, implementations of the present disclosure can substantially reduce the time required by users. In turn, this eliminates the expenditure of substantial quantities of computer resources that a user would otherwise use (e.g., compute cycles, power, memory, etc.). Further, by reducing the time expense of users, implementations of the present disclosure can increase efficiency across a number of use-cases (e.g., software engineering, medical research, citing documents for research papers, etc.). Moreover, as personal user data is not provided to the generative model for generating smart-chips based on user data (e.g., email address chips based on a user's address book), user privacy is protected. Additionally, as the generative model does not need to populate user information-based fields based on personal user data, and similarly, as the computing system only needs to populate the user information-based fields based on the personal user data after the generative model has been refined/regenerated, substantial quantities of computer resources (e.g., compute cycles, power, memory, etc.), that would otherwise be used by the generative model and/or computing system, are eliminated.

With reference now to the Figures, example embodiments of the present disclosure will be discussed in further detail.

### Example Devices and Systems

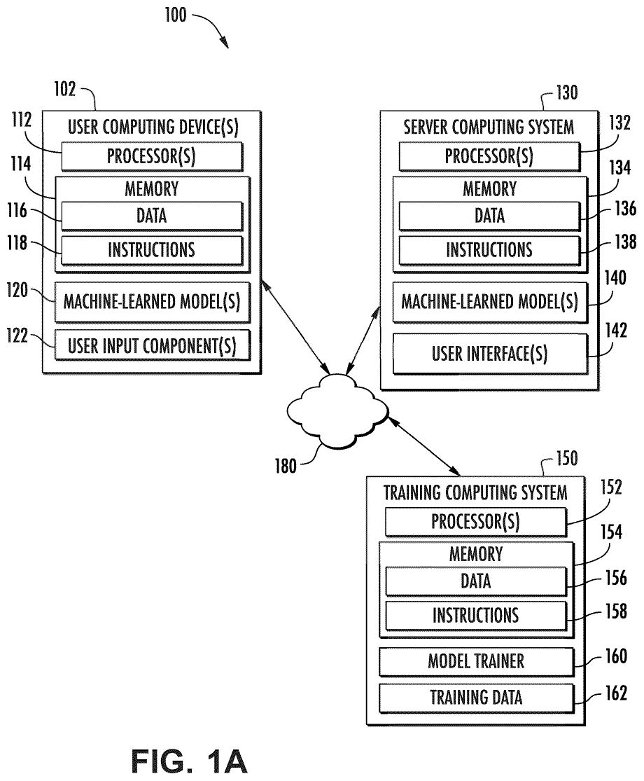

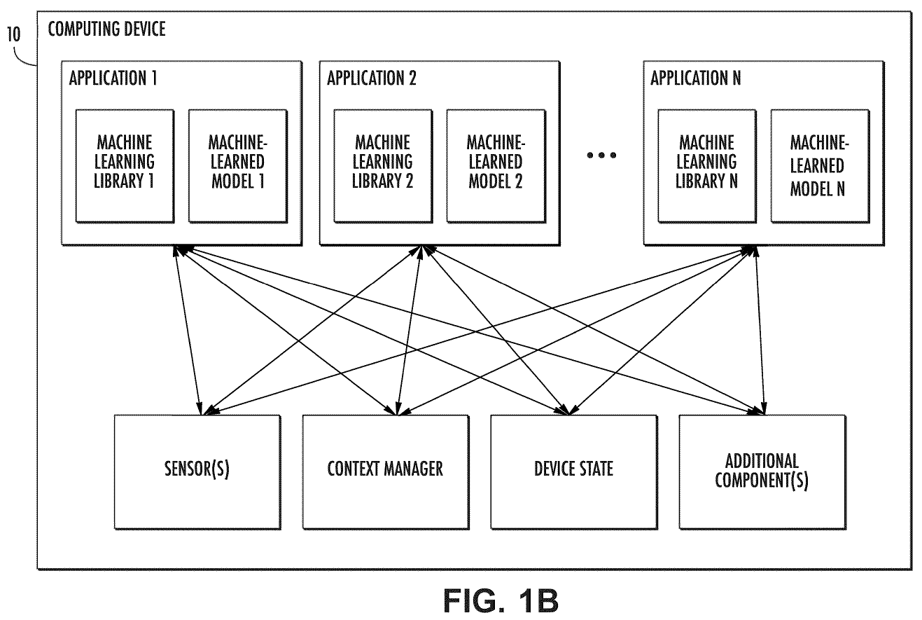

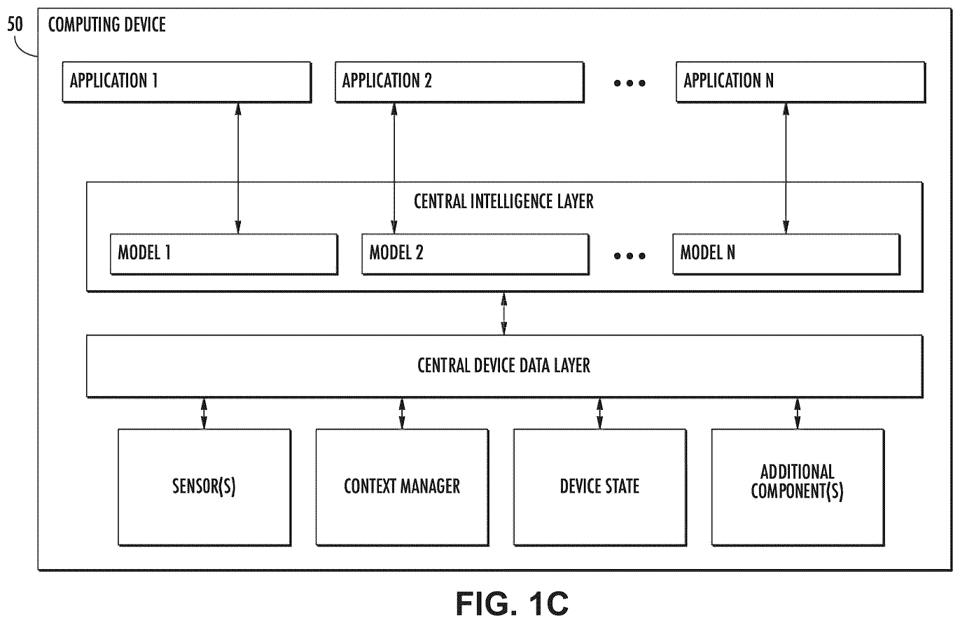

FIG. 1A depicts a block diagram of an example computing system 100 that generates structured content using generative models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

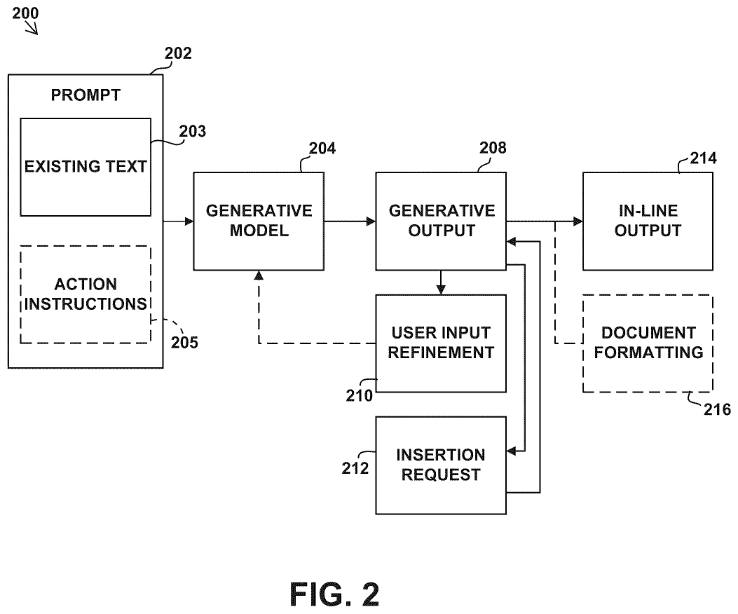

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 120 are discussed with reference to FIGS. 2-14.

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120 (e.g., to perform parallel generative content generations using such model(s) 120 across multiple instances of content requests).

More particularly, the generative model 120 can be trained to process a prompt and generate content based on the prompt. The content can include text (e.g., a response to a question in the prompt), one or more images, one or more audio files, and/or other content. The generative model 120 can include a large language model, a text-to-image model, and/or the like. In some implementations, the language model can additionally be utilized for tokenization determination, autocompletion, template generation, and/or prompt term suggestions during the prompt crafting process.

Additionally, or alternatively, one or more models 140 can be included in or otherwise stored and implemented by the server computing system 130 that communicates with the user computing device 102 according to a client-server relationship. For example, the models 140 can be implemented by the server computing system 130 as a portion of a web service (e.g., a content generation service). Thus, one or more models 120 can be stored and implemented at the user computing device 102 and/or one or more models 140 can be stored and implemented at the server computing system 130.

The user computing device 102 can also include one or more user interface components 122 that receives user input and/or provides user interfaces to a user. For example, the user interface component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user interface components include a microphone, a traditional keyboard, camera, or other means by which a user can provide user input and/or experience user interfaces.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-14.

The server computing system 130 may include, store, and/or access a user interface 142 that can be utilized to interface with one or more users. The user interface 142 can be utilized to obtain inputs from the user via communication with the user interface component(s) 122 and may be utilized to provide outputs for display. The user interface 142 may include a development environment interface, through which a machine-learned model(s) 120, 140 is accessible.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be back-propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated back-propagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. The training data 162 can include, for example, example prompts, example templates, example language data, example image data, example labels, example tokens, and/or term replacements.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output, image description output (e.g., natural language description of the image), and/or the like. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output. As an additional example, the machine-learned model(s) can process the text or natural language data to generate computer language (e.g., a code block, and/or the like) responsive to the processed text or natural language. For instance, if the text or natural language is “write a program that says ‘Hello World’,” the machine-learned model(s) may return a code for a program that says “Hello World.”

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output. As an additional example, the machine-learned model(s) can process the speech data to generate computer language (e.g., a code block, and/or the like), responsive to the processed speech. For instance, if the speech is “write a program that says ‘Hello World’,” the machine-learned model(s) may return code for a program that says “Hello World.”

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example 200 for generating structured content using generative models according to example embodiments of the present disclosure. In particular, input data 202, such as a prompt, (e.g., a plurality of input characters descriptive of a prompt request) can be obtained by a machine-learned model 204 from a user based on interaction of the user with the user interface 142 via the user interface component(s) 122. The prompt 202 may be in the form of natural language, a combination of natural language and another form(s) (e.g., image), or any other suitable form(s). In some instances, as will be described in greater detail below, the machine-learned model 204 may be accessible from within an integrated development environment (e.g., word processor, and/or the like). For example, the prompt 202 may be selected text or existing content 203 within the integrated development environment, content newly generated within the integrated development environment (e.g., action instructions 205 within a prompt window provided within the integrated development environment interface), and/or the like. In some instances, the prompt 202 may include unpaired inputs, and optionally, paired inputs (e.g., inputs with corresponding outputs for training). As will also be described in greater detail below, in some implementations, document formatting rules for the integrated development environment may also be provided with the prompt 202 to the generative model 204, where the generative model 204 may pass such formatting rules along with any output.

In some implementations, the prompt 202 can be processed by one or more machine-learned generative models 204 to determine an intent of the prompt 202 and generate a generative output 208 responsive to the prompt 202. For instance, the generative model 204 can include any of the model(s) 120, 140 described above with reference to FIGS. 1A-1C, such as one or more transformer models, may include one or more autoregressive language models, may include one or more stable diffusion models, and/or the like. The generative output 208 may include generated content text data, image data, audio data, latent encoding data, and/or statistical data. Particularly, the generative output 208 includes the generated content structured or separated into generative output cells (e.g., in a table). In some instances, the generative content includes outputs for pairing with unpaired inputs of the prompt. In one instance, the generative content includes suggested content based on the prompt.

The success of the generative output 208 may be evaluated. For example, in some implementations, a user interface (e.g., the user interface 142) may be utilized to receive refinement feedback 210 from the user regarding editing (e.g., refining) one or more parts of the generative output 208 (e.g., add or delete cells), generating a new generative output 208 (e.g., re-submitting the prompt 202 to the generative model 204, with the generative model 204 providing non-deterministic outputs), and/or receiving an updated prompt for generating an updated generative output 208. The generative model 204 may then refine the existing generative output or generate a new generative output in response to the refinement feedback 210.

Generally, as will be described below in greater detail, the generative output 208 may be provided in a preview format, separately of in-line content within the integrated development environment. Thus, if no refinement feedback 210 is received, or once the refinement feedback 210 has been addressed, an insertion request 212 may be received from the user via a user interface (e.g., the user interface 142) to insert the generative output 208 in-line into the integrated development environment. Particularly, the content within the generative cells of the generative output 208 may be inserted in-line (e.g., into cells) within the integrated development environment in the same layout suggested by the generative cells.

In some instances, the generative model 204 may not be configured to format the generative output 208. For example, the generative model 204 may be trained only to provide the generative content 208 within a particular structure (e.g., within cells in tabular form, and/or the like), where the structure may be generated by the generative model 204 or selected by the generative model 204 from a known structure, but the generative model 204 may not be constrained to providing the generative content 208 according to formatting rules (e.g., a particular font, font size, emphasis (e.g., highlight, bold, italic, underlined, strike-throughs, etc.)), let alone the formatting rules of the intended insertion environment (e.g., the integrated development environment). As such, before insertion, a computing system (e.g., server computing system 130) may additionally, or alternatively, be configured to generate the modified output 214) based on the generative output 208 and formatting rules (e.g., such as formatting rules set within the intended insertion environment). For instance, the computing system may create the modified output 214, outside of the generative model 204, by automatically formatting the generative output 208 according to formatting rules. For example, the generative output 208 may have different content levels (e.g., headings, subheadings, body, and/or the like) defined by the generative model 204 and/or otherwise parsed/identified by the computing system, where the computing system may apply the formatting rules (e.g., font size, font style, font color, text wrapping, text direction, cell fill color, etc.) defined for the different content levels to the different content levels within the generative output 208 before the generative output 208 is inserted in-line within the integrated development environment. As such, the generative output 208 may be automatically formatted, outside of the model 204, where the formatted generative output 208 may then be inserted in-line within the integrated development environment while matching the formatting within the integrated development environment and without requiring manual user adjustment.

However, in some instances, the model 204 may additionally, or alternatively, suggest formatting rules based on the different content levels (e.g., headings, subheadings, body, and/or the like) defined or identified within the generative output 208 generated by the generative model 204, then apply the formatting rules or instruct the computing system (e.g., server computing system 130) to apply the formatting rules upon insertion in-line within the integrated development environment. As such, the generative output 208 may be automatically formatted when inserted in-line within the integrated development environment without requiring manual user adjustment.

In some instances, the generative output 208 identifies or requests one or more smart chips. For instance, the prompt may include existing content that could be made “smart.” For example, if the existing content in the prompt includes a list of names, the generative output may include or instruct the computing system to make smart chips linking each name to further information from a user's address book (e.g., to an email address associated with the name, to a phone number associated with the name, and/or the like) where the generative output will replace the existing content with the smart chip upon insertion. Similarly, if the existing content in the prompt includes a list of items that use a small list of categories (e.g., “low,” “medium,” and “high”; “started,” “not started,” “done,” “blocked”; “1,” “2,” “3”; etc.), the generative content will generate a smart drop-down list with the categories and select the most appropriate category from the drop-down for each of the list of items, where the drop-down selections will replace the existing content. Other examples of smart chip replacements include check-box lists (e.g., to replace “yes” and “no”), website or file explorer address linking, and/or the like.

In some instances, the generative model 204 may not be given the information for smart chips corresponding to personal user information (e.g., fields for a user's name, contact information, contacts, calendar events, or associated locations) or other unknown information (e.g., event details, and/or the like). As the generative model 204 is only trained using general information (not information specific to the user associated with the prompt) and relies on the prompt to provide specific details, such field(s) may be un-filled. Instead of requiring a user to manually populate such smart chips after the generative output 208 is inserted in-line within the integrated development environment, a computing system (e.g., server computing system 130 and/or user computing device 102) may modify the generative output 208 based on personal, historical user data 216 (e.g., stored and/or accessed from memory 134, memory 114, etc.). For instance, the computing system may modify the generative output 208 by automatically populating the smart chip defined or instructed within the generative output 208 with appropriate user information 216. For example, the modified generative output 208 may link a name field in the generative output 208 with contact information (e.g., an email address, a phone number, and/or the like). As such, the generative output 208 may be automatically personalized, separate from the model 204, to create the modified generative output 208 (e.g., populated smart chip), where the modified generative output 208 may then be inserted in-line within the integrated development environment, without requiring manual user population or entry of the user information-related fields.

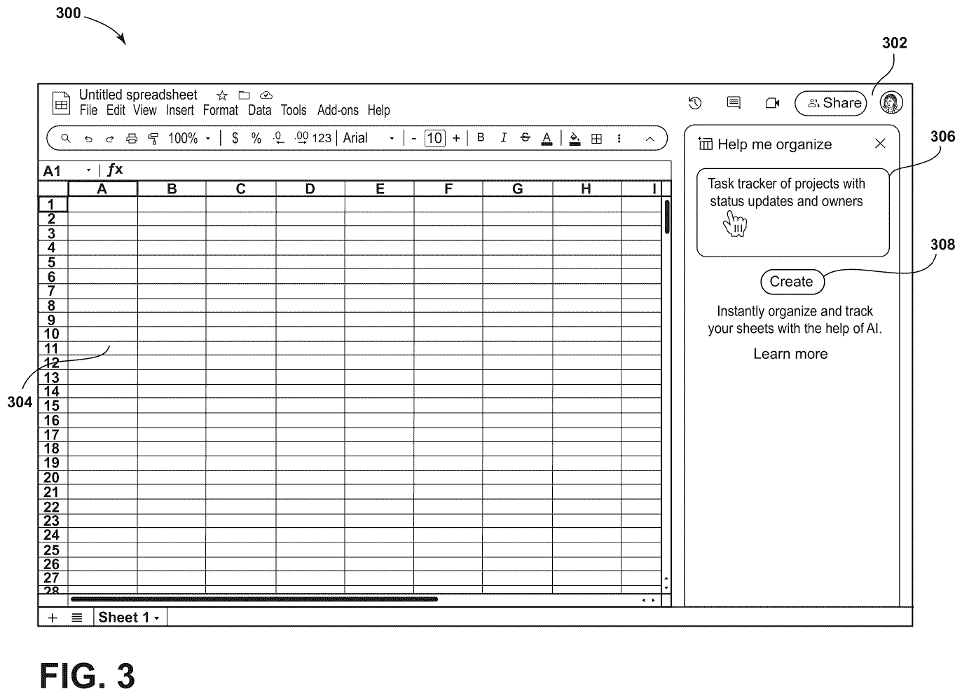

FIG. 3 depicts an illustration of an example interface 300 for interacting with a generative model for generating generative output content within a collaborative, integrated development environment according to example embodiments of the present disclosure. In particular, the example interface 300 may include an integrated development environment 302 (e.g., a spreadsheet program, a word processor, etc.) accessible with the user interface 142 (e.g., via the user interface component(s) 122). The integrated development environment 302 may include a general workspace 304 configured to receive inputs (e.g., text, images, and/or the like) from a user and provide or display such inputs in-line within the general workspace 304. It should be appreciated that, as used herein, “in-line” is considered to mean content within or insertable into the general workspace 304 such that it is subject to formatting rules of the general workspace 304 and/or embedded into the general workspace 304. For instance, the integrated development environment 302 may provide one or more format selection interface elements with which a user may interact for selecting or defining formatting rules (e.g., content level (e.g., heading, subheading, normal body, etc.), font style, font size, font emphasis (e.g., bold, italicize, underline, color, highlight), paragraph style, numbering, bulleting, and/or the like) for content (e.g., text) in-line within the general workspace 304. In the illustrated example, the general workspace 304 is divided into structured cells (e.g., organized into rows and columns) for receiving content/inputs.

The example interface 300 can be configured to receive a prompt (e.g., prompt 202 in FIG. 2) for submission to a generative model (e.g., model 204 from FIG. 2) from a user via the general workspace 304 of the integrated development environment 302. For instance, as shown in the example of FIG. 3, the integrated development environment 302 has a generative area 306 broken-out or separated from the rest of the general workspace 304, where a user may type or otherwise provide the prompt within the generative area 306. In the illustrated example, the generative area 306 is in a side-bar or side-pane area of the integrated development environment 302, separate of the general workspace 304, and includes a field for a user to provide the prompt. However, in other embodiments, the generative area 306 may overlay at least a portion of the general workspace 304. For instance, as will be described in greater detail below, the prompt may be provided by selecting existing content, such that the generative area 306 is not explicitly shown. Once the user has finished providing the prompt, the user may request that the prompt be submitted or otherwise provided to a generative model by pressing enter or clicking a request button 308 (e.g., button labeled “create”) associated with the generative area 306. After the model has generated generative content responsive to the prompt, the model may display the generative content within the integrated development environment 302 (e.g., within the generative area 306 or in the area of the general workspace 304).

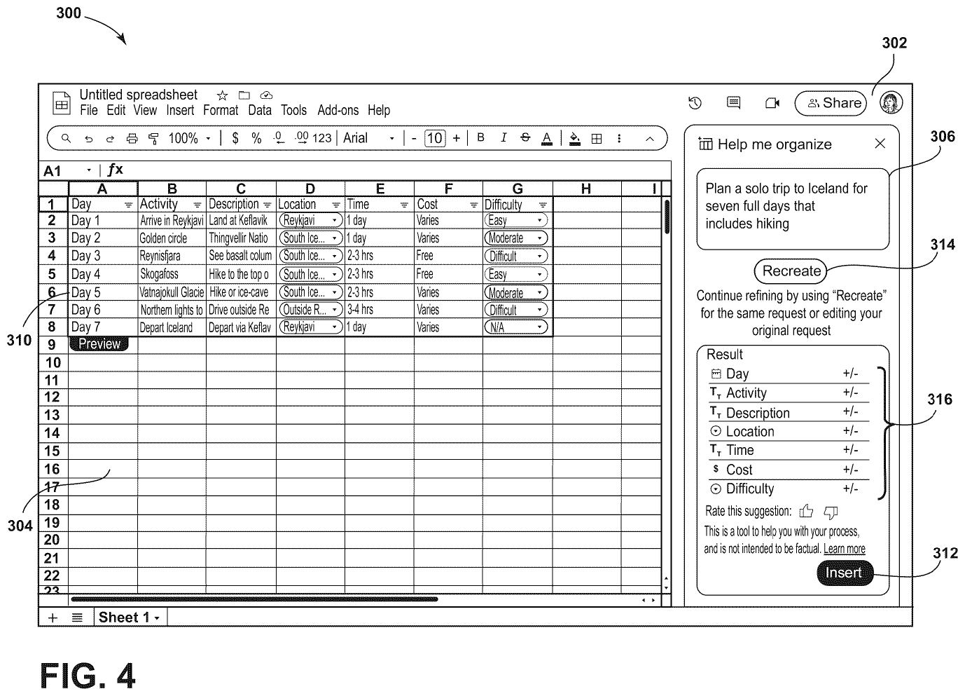

For instance, FIG. 4 depicts an illustration of an example interface interaction for providing a prompt to a generative model for generating generative output content and receiving a generative output from such generative model in response to the prompt according to example embodiments of the present disclosure. As particularly shown in FIG. 4, a user provided a prompt “Plan a solo trip to Iceland for seven full days that includes hiking,” within the generative area 306 and clicked the request button 308 (FIG. 3). In response to the prompt, the model provides a generative output 310 within the integrated development environment 302. For example, the generative output 310 includes a table within the integrated development environment 302 and populated with itinerary details generated by the model, including itinerary “Day” (e.g., “Day 1,” “Day 2,” . . . “Day 7”), itinerary “Activity” (e.g., “Arrive in Reykjavi . . . ,” “Golden Circle,” . . . “Depart iceland”), “Description” (e.g., “Land at Keflavik . . . ,” “Thingvellir Natio . . . ,” . . . “Depart via Keflav . . . ”), “Location” (e.g., “Reykjavik,” “South Ice . . . ,” . . . “Reykjavik”), “Time” (e.g., “1 day,” “1 day,” . . . “1 day”), “Cost” (e.g., “Varies,” “Varies,” . . . “Varies”), and “Difficulty” (e.g., “Easy,” “Moderate,” . . . “N/A”). In some instances, the generated table also applies a filter for each itinerary field or category (e.g., for each column-“Day,” “Activity,” “Description,” “Location,” “Time,” “Cost,” “Difficulty”). Additionally, or alternatively, in some instances, the generative content of the generative output 310 may include smart chips. For instance, in the illustrated embodiment, the “Location” column is populated using selections from a drop down list (e.g., drop down list including popular locations around Iceland) and the “Difficulty” column is populated using selections from another drop down list (e.g., drop down list including “Easy,” “Moderate,” “Difficult,” and “N/A”). As such, a user may quickly change locations or a difficulty level after the generative output 310 is inserted into the general workspace 304.

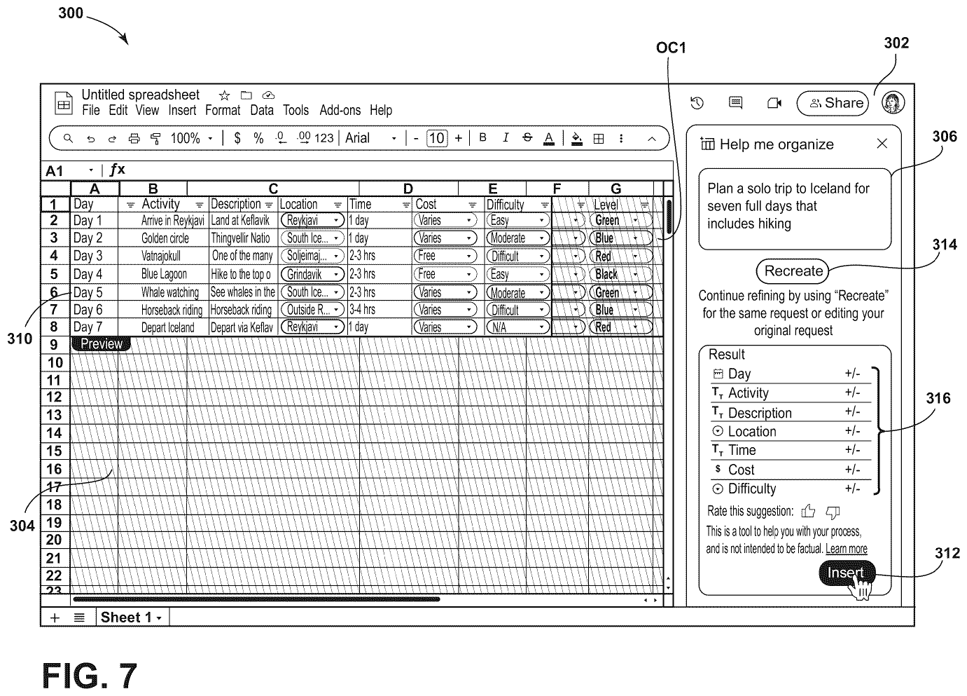

Particularly, in some embodiments, it is preferred that the generative output 310 remains separate from in-line content within the rest of the general workspace 304 until a user requests insertion of the generative output 310 into the general workspace 304. For instance, as shown in FIG. 4, fields of the generative output 310 (e.g., “Day,” “Activity,” “Description,” “Location,” “Time,” “Cost,” “Difficulty”) are summarized within the generative area 306, separate of in-line content within the rest of the general workspace 304 and a “preview” of the generative output 310 is shown in the general workspace 304. In some instances, the preview may appear in-line in the general workspace 304, or may appear above or in-front of in-line content within the general workspace 304. For instance, in FIG. 7, the generative output 310 is overlaid on top of original content OC1 in the general workspace 304 which will be replaced by the generative output 310. In one or more instances, the preview of the generative output 310 may be provided in-line with content within the general workspace 304, but visually separated from the other in-line content by different formatting (e.g., highlighting, bolding, italics, and/or the like) instead of by a box. In some instances, the preview maintains the formatting (e.g., column spacing, row spacing, text size, font style, fill color, text wrapping, etc.) present in the general workspace 304. However, in other embodiments, the preview may have a different formatting appearance than the general workspace 304 to improve readability, for example, to wrap text such that all text is visible, and/or the like.

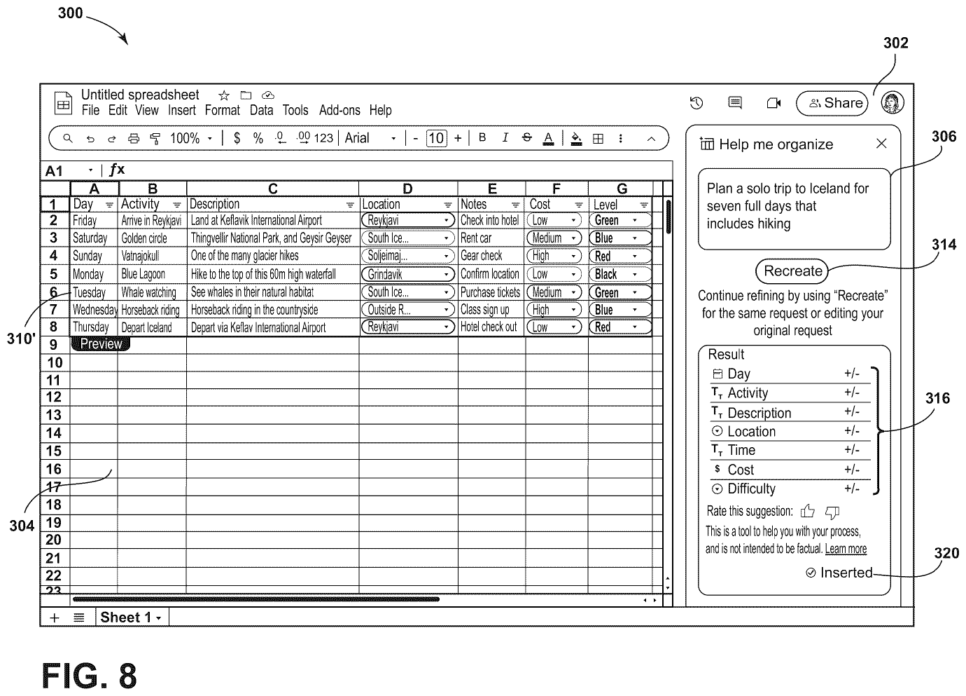

If a user approves of the generative output 310 generated by the model, a user may then request that the content of the generative output 310 be inserted in-line within the general workspace 304. For instance, the user may press enter or click an insert button 312 associated with the generative area 306 or the generative output 310. As shown in the example of FIG. 8, after a user has clicked to insert the generative content (e.g., generative content 310′) into the integrated development environment 302, the generative content is in-line within the general workspace 304.

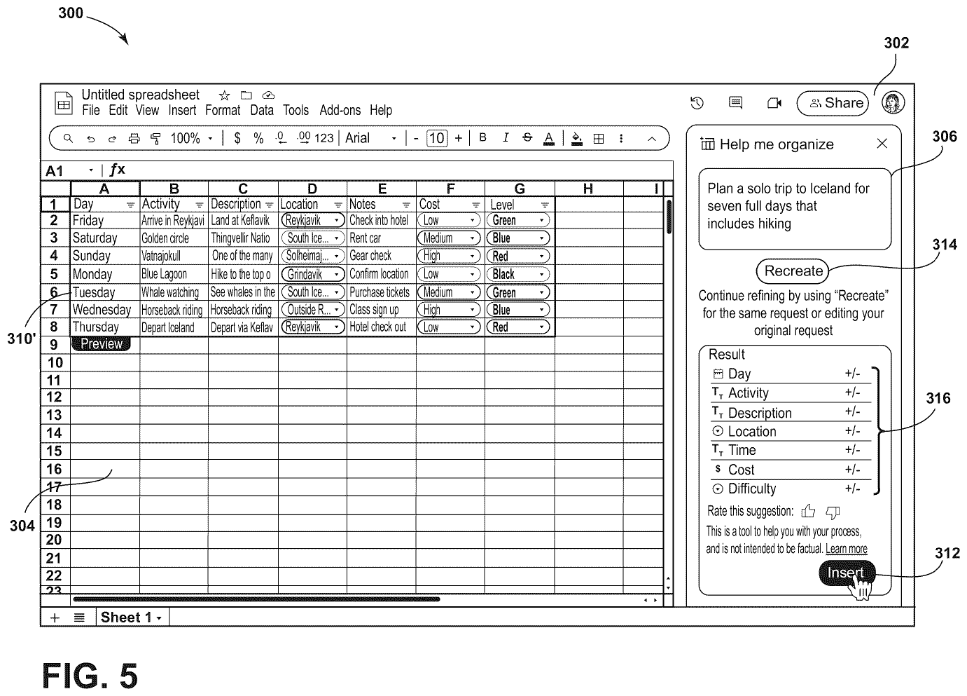

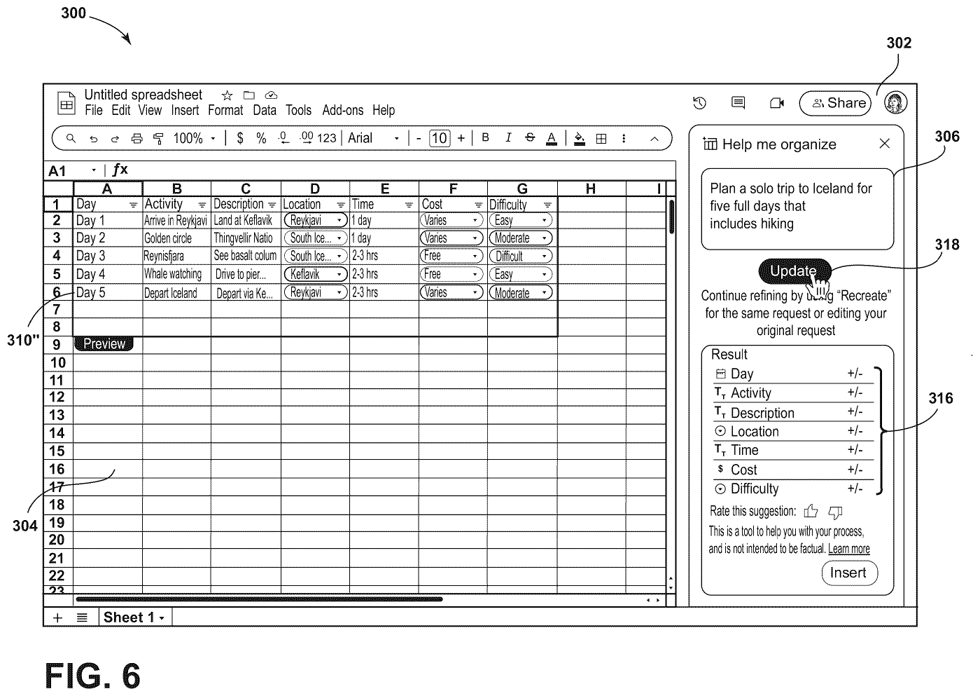

Otherwise, a user may request refinement or replacement of the generative output 310. For example, a user may click a regeneration or recreate button 314 (e.g., when the model provides non-deterministic outputs) associated with the generative area 306, and thus, the generative output 310, a user may click one or more refinement request buttons 316 (e.g., “+/−” associated with adding or removing generative fields), and/or a user may alter the prompt in the generative area 306 (FIG. 6) and click an update button 318 associated with the generative area 306, and thus, the generative output 310. Once a user selects one of the refinement or replacement options or otherwise provides a different request, the model may refine the generative output 310 in light of the desired refinement or replacement and display the updated generative content within the integrated development environment 302 (e.g., within the generative area 306). For instance, the model may receive the desired refinement or replacement request and the generative output 310 as input, and return the refined or updated generative content. For example, if a user clicks the recreate button 314 in FIG. 4, the recreated generative content 310′ is provided in FIG. 5 (e.g., having “Monday,” “Tuesday,” . . . “Friday” instead of “Day 1,” “Day 2,” . . . “Day 7”, having a “Notes” column instead of a “Time” column, having different difficulty levels, and having different activities compared to the generative output 310 in FIG. 4). Similarly, if a user changes the prompt within the generative area 306 to “Plan a solo trip to Iceland for five full days that includes whale watching,” as in FIG. 6, then clicks the update button 318 in FIG. 6, the updated generative output 310″ is provided in FIG. 6 (e.g., having “Whale watching” as an activity and only having five itinerary days).

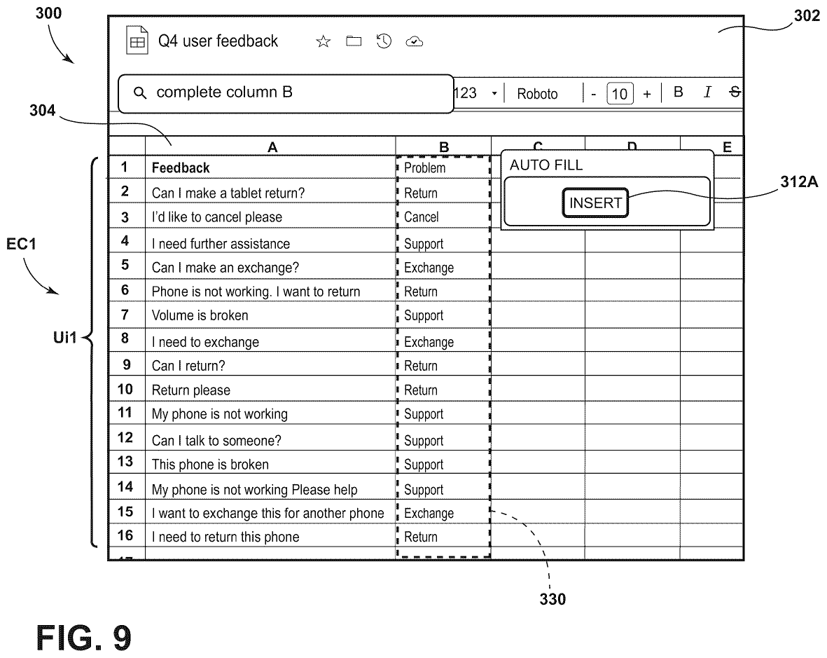

In some instances, a prompt may be provided to the model by selecting existing content within the general workspace 304. For instance, FIGS. 9-12 depict illustrations of example interface interactions for providing a prompt to a generative model for generating generative output content and receiving the generative output from such generative model in response to the prompt according to example embodiments of the present disclosure. For example, as shown in FIG. 9, existing content EC1 (e.g., column A) within the general workspace 304 may be provided to the model. The existing content EC1 may be provided passively, without user input, by the integrated development environment 302 or actively via user input to the model (e.g., user may select an input range of the existing content EC1). In some instances, such as the example shown in FIG. 9, the existing content EC1 only includes unpaired inputs Ui1. In one instance, a field 306A may be provided where a user may provide processing instructions (e.g., natural language prompt “complete column B”) in the field 306A for the model to process the selected unpaired inputs Ui1. The field 306A may be part of the generative area 306 or may be separate. After the processing instructions are provided, the user may submit the prompt to the model. For example, in some instances, “create” button (not shown) may appear when a user enters processing instructions. However, it should be appreciated that the user may submit the prompt in any other suitable manner. The generative output 330 generated by the model includes an output (e.g., “Return,” “Cancel,” . . . “Return”) for pairing with each of the unpaired inputs Ui1, where the generative output 330 is separated from in-line content within the general workspace 304 by a dashed box, and/or the like. The generative output 330 may be inserted in-line by clicking the insert button 312A.

It should be appreciated that the processing instructions may include more specific requests for generating the generative content by at least one of classifying or characterizing the existing content, extracting details from the existing content, summarizing the existing content, cleaning up or standardizing the existing content, suggesting additional content based at least in part on the existing content, and/or the like. For example, classifying or characterizing the existing content could include identifying a sentiment or theme of the existing content. For instance, if the selected unpaired inputs Ui1 included addresses for different recipients, a request to classify or categorize the existing content could be requesting a region and/or the like for each of the name and address combinations. Similarly, extracting the existing content could include splitting text into multiple columns or identifying a certain detail from a first column in a second column. For example, if the selected unpaired inputs Ui1 included addresses for different recipients, a request to extract details from the existing content could be requesting a state for each of the name and address combinations and/or the like. Cleaning up or standardizing the existing content generally includes unifying formats across different content points. For instance, if the selected unpaired inputs Ui1 included addresses for different recipients, a request to standardize the unpaired inputs Ui1 could be requesting for each of the name and address combinations to appear the same way (e.g., with the same block format, separated across columns for different fields (e.g., name column, street address column, zip code column, area code column, state column, etc.), combined into a single field, etc.). Summarizing the existing content generally includes condensing text. Suggesting additional content based on the existing content could include generating tables based on a title or given natural language details, similar to as described above with reference to FIGS. 3-8.

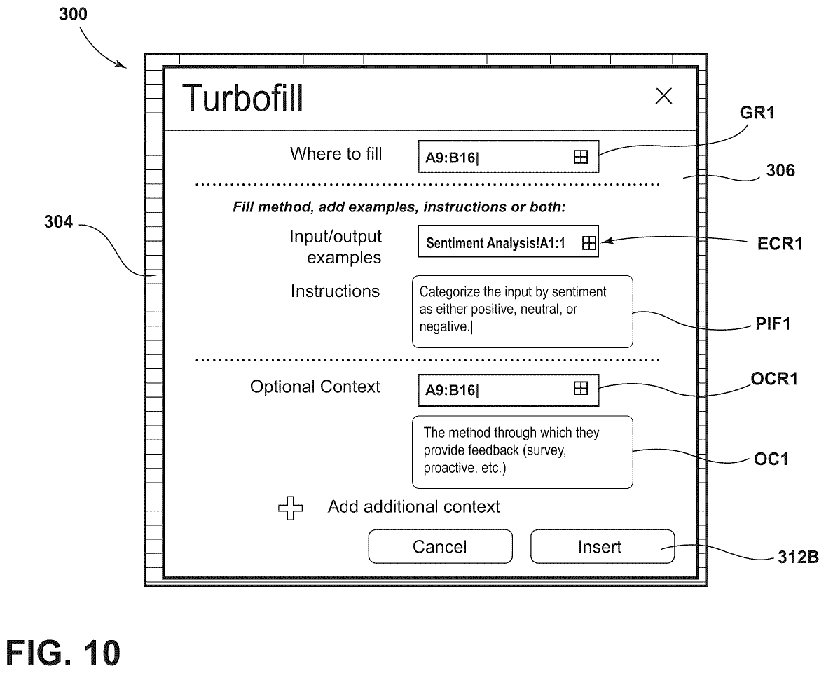

In some instances, as shown in FIG. 10, the generative area 306 may include a dialog box having multiple fields for indicating existing content and/or other relevant information for the prompt. For instance, the generative area 306 may include a generation range field GR1 for receiving which area or range (e.g., cells “A9: B16”) within the general workspace 304 of the integrated development environment 302 is intended to be populated with the generative content. Similarly, in some instances, the generative area 306 may include an existing content range field ECR1 for receiving existing content (e.g., “‘Sentiment Analysis’ A1:1”) within the general workspace 304 of the integrated development environment 302. In some instances, the generative area 306 may include a processing instructions field PIF1 for receiving natural language instructions of the prompt (e.g., “Categorize the input by sentiment as either positive, neutral, or negative.”). In one instance, additional context may be provided with the prompt to the model. For example, the generative area 306 may include an optional context field range OCR1 for selecting a range of cells (e.g., cells “A9: B16”) for which optional context (e.g., “The method through which they provided feedback (survey, proactive, etc.)”) received in an optional context field OC1 may additionally be applied. The optional context may be used to improve the certainty, accuracy, etc. of the generative output 310. After one or more fields of the generative area 306 are filled, the generative output 310 may be previewed in any of the ways described above, and a user may subsequently click an insert button 312B to insert the generative output 310 in-line within the general workspace 304 when the user is satisfied with the generative output 310.

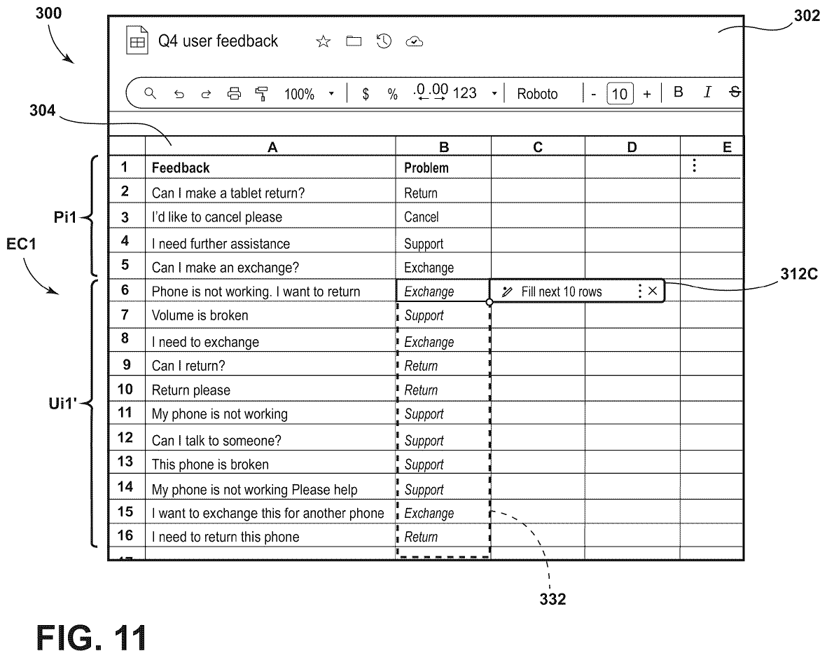

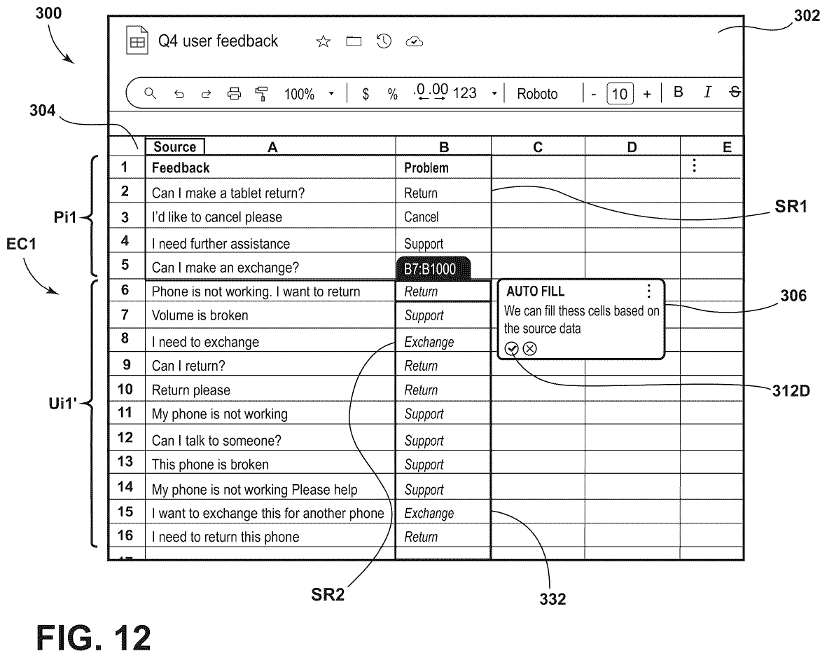

In one or more instances, the model may receive the existing content EC1 from the integrated development environment 302 and suggest auto-populating the outputs with generative content to be associated with the unpaired inputs. For instance, in FIGS. 11 and 12, the existing content EC1 includes both unpaired inputs Ui1′ and paired inputs Pi1. For example, the paired inputs include the received feedback (e.g., “Can I make a tablet return?”, “I'd like to cancel please,” “I need further assistance,” and “Can I make an exchange?”) in a first column and received problem (e.g., “Return,” “Cancel,” “Support,” and “Exchange”) in a second column, where the paired feedback and problem in each row may be used as training examples in the prompt supplied to the model. The unpaired inputs include only received feedback (e.g., “Phone is not working. I want to exchange,” “Volume is broken,” . . . “I need to return this phone”). The model may identify a pattern from the paired inputs Pi1 and suggest applying the pattern to the unpaired inputs Ui1′ to generate the generative output 332 when the unpaired inputs Ui1′ cases match the pattern or relationship. For example, the model passively receives the existing content EC1 from the integrated development environment 302 in FIG. 11, without a user explicitly requesting creation, determines that the problem from column A is provided in column B, and the model suggests auto-populating the outputs (e.g., “Fill next 10 rows”) with the generative content 332 to be associated with the unpaired inputs when the unpaired inputs Ui1′ have similar content as the inputs from the paired inputs Pi1. As such, the generative output 332 includes a problem category or classification for each unpaired feedback (e.g., “Exchange,” “Support,” . . . “Return”) in accordance with the trained examples. The generative content 332 may be inserted in-line when the user clicks on the insert button 312C (e.g., labeled “Fill next 10 rows”).

In some instances, as shown in FIG. 12, the model may indicate to a user of the integrated development environment one or more of the paired inputs Pi1 from which the pattern may be deduced as a source range SR1, indicate a range (e.g., second range SR2, the outputs for the unpaired inputs Ui1′) that can be auto-populated based on the pattern (e.g., “We can fill these cells based on the source data”), and may provide a preview of such generative output 332. If a user provides the insertion request (e.g., by clicking the check mark 312D), the generative output 332 is inserted in-line within the general workspace 304. When the source and auto-population ranges SR1, SR2 are indicated to a user, the confidence in the auto-populations may increase, and adjustments to the ranges SR1, SR2 are made possible, which further increases confidence and flexibility.

It should be appreciated that, in some instances, when existing content is used as a prompt, the formatting of the existing content may be preserved. For instance, the formatting rules applied to the existing content (e.g., as selected using the formatting selection elements) may be embedded within the existing content, such that when the existing content is provided to the model, the model outputs the output content and passes along the formatting rules with the output content, where the formatting rules passed along with the output content may then be applied when subsequently inserting the output content in-line within the general workspace 304, outside of the generative area 306. For example, when the generative output 330 shown in FIG. 9 is requested to be inserted within the general workspace 304, the generative output 330 will be formatted (e.g., by the computing system(s) 102, 130, separately of the model) to match the formatting of the portion of the general workspace 304 in which the generative output 330 is to be inserted (e.g., normal or body level content having a certain font type, font size, text wrapping, cell size, text direction, fill color, text color, etc. while the heading level content may similarly have a certain font type, font size, text wrapping, cell size, text direction, fill color, text color, etc.).

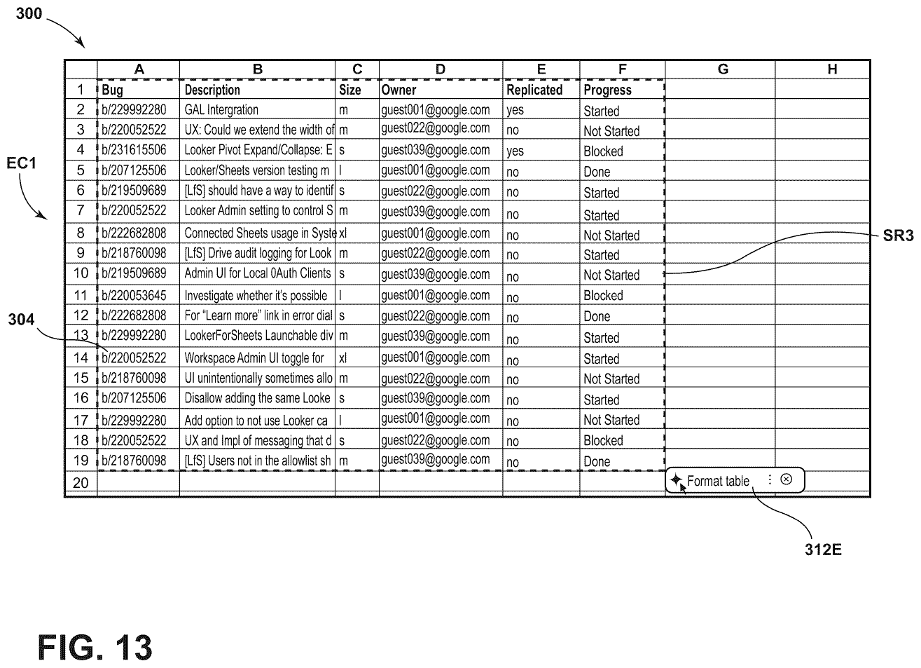

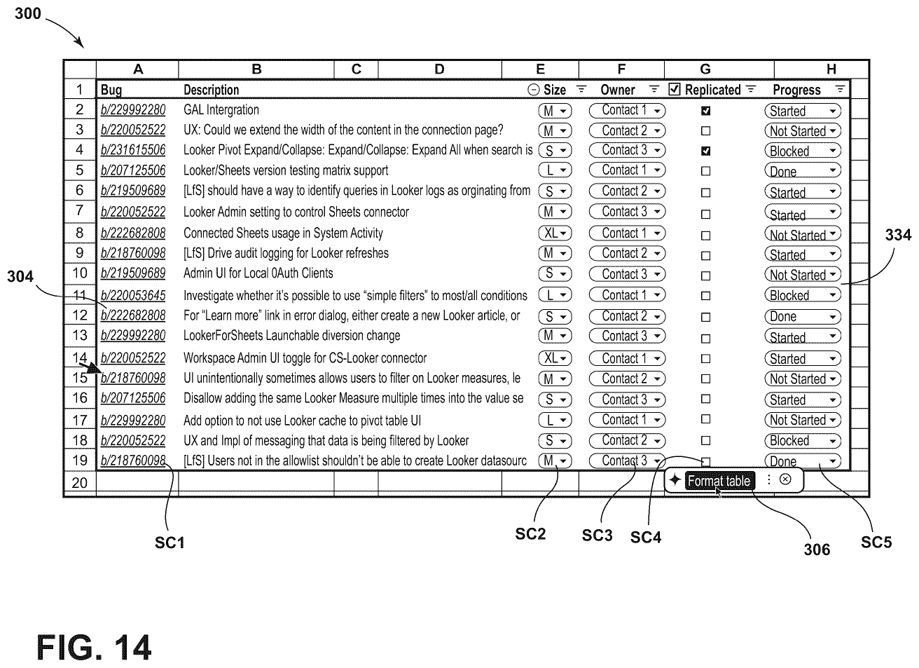

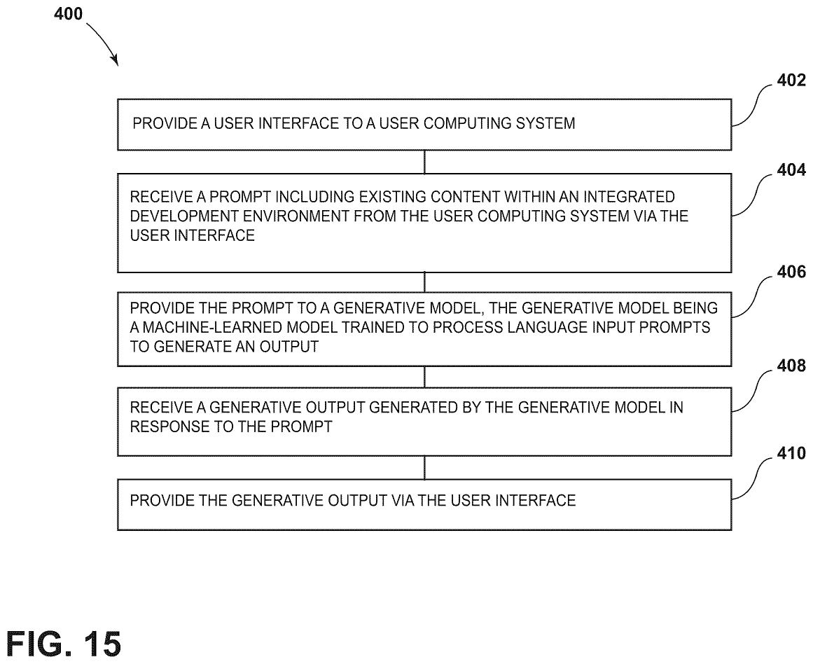

Turning now to FIGS. 14 and 15, existing content EC1 may require extensive formatting to be readable and/or usable, which can be time consuming. For example, the existing content EC1 may include content that could be made “smart,” but typically must be manually provided smart chips linking or formatting the existing content with additional context. For instance, as shown in FIG. 13, the existing content EC1 may include content that may typically be manually linked or made smart. For example, the first column (column A) includes a list of common software bugs (e.g., “b/229992280”, “b/220052522”, etc.), the third column (column C) indicates the size of the issue (e.g., small “s”, medium “m”, large “1”, “x1”), the fourth column (column D) provides email addresses without hyperlinks, the fifth column (column E) provides indication of whether or not the bug has been replicated (e.g., “yes” or “no”), and the sixth column (column F) provides indication of the progress of the bug fix (e.g., “Started,” “Not started,” “Blocked,” “Done”). Instead of a user having to manually create hyperlinks, drop down boxes, check boxes, and/or the like, a user may simply select a range SR3 of the existing content EC1 and request automatic formatting of such range (e.g., by clicking the “Format table” button 312E). The model may then receive the range SR3, identify groups of information that may be made smart, and provide smart chips or instructions for the computing system to generate such smart chips.

For instance, as shown in FIG. 14, in the generative output 334, the model hyperlink formats the common software bugs (e.g., “b/229992280”, “b/220052522”, etc.) in the first column (column A) to further information about the data bug. For example, the model may have access to the information about each of the bugs from other areas within the integrated development environment (e.g., within a respective sheet of the same book within the integrated development environment 302). As further shown in FIG. 14, the model automatically populates a drop-down list based on the existing content within the third column (column C) indicating the size of the issue (e.g., small “s”, medium “m”, large “1”, “xl”) and selects a drop-down option for each of the rows based on the existing content within the third column. The model provides checkboxes for each row indicating that the bug has been replicated when checked in the fifth column (column E) instead of the text “yes” or “no”. Moreover, the model provides another drop-down list based on the existing content within the sixth column (column F) indicating of the progress of the bug fix (e.g., “Started,” “Not started,” “Blocked,” “Done”) and selects a drop-down option for each of the rows based on the existing content EC1 within the sixth column. Additionally, the generative output 334 includes contact information smart chips for each of the email addresses in the fourth column (column D). For instance, a name associated with each email address is provided and hyperlinked to the email address and/or other contact information.

Each of the columns not provided with smart content can also be filtered and formatted by the model. For instance, the first row of the generative output 334 is given different shading as a heading row than the other rows, and each of the columns of the first row is provided a filter. By automatically providing drop-down lists and check boxes, the number of variations that need to be selected when filtering is reduced (e.g., “started” and “In progress” in existing content would be simplified to “started” for the drop-down list). The generative output 334 provided in FIG. 14 replaces the existing content EC1 from FIG. 13 within the general workspace 304 upon acceptance and insertion.

In some instances, the model is only configured to define or indicate that certain fields of the smart chips are to be populated. For instance, in some implementations, the model is not passed or otherwise provided user information with the prompt. Particularly, the model is not provided historical, personal user information, such as a name of the user, contact information, contacts, calendar events, location history, and/or the like, unless it is provided within the prompt by the user. It should be appreciated that “historical user information” is used herein to mean user information defined during a separate interaction from the present request for generated content, such as an interaction before the prompt is provided. For instance, historical user information may be defined by a user during set-up of a user profile for use with the integrated development environment 302 or other environments linked, in communication with, or otherwise tied to the integrated development environment 302, may be learned based on interactions of the user within the development environment 302 or connected development environments (e.g., a user typing their name in fields that say “name”), and/or the like. The historical user information may be saved in the memory of a user computing device being used to interact with the integrated development environment (e.g., memory 114 of user computing device 102 in FIG. 1) and/or in the memory of a server computing system hosting the user interface for accessing the integrated development environment (e.g., memory 134 of server computing system 130 in FIG. 1), and/or may otherwise be accessible by such server computing system. As the model does not have user information, the model provides or defines variables or fields within the template for such information to be populated separately of the generative content being created, for instance, for population by the server computing system hosting the integrated development environment (e.g., by server computing system 130 in FIG. 1).

Using the example of the smart chips for column F, the model may not have access to a user's address book, which has entries correlating a name to an email address, phone number, company, etc. In such instance, the model may provide instructions to the computing system that provides the integrated development environment (e.g., the server computing system that manages user account information including the user's address book) to populate the fields of the smart chips with the requested information (e.g., contact name) upon insertion in-line.

The different examples of user interfaces and interactions described above with reference to FIGS. 3-14 may be combined or used separately to provide a way to generate structured content within a generative environment using generative models (e.g., large language models) in response to prompts received from within the integrated generative environment). Aspects of the present disclosure provide a number of technical effects and benefits. As one example technical effect and benefit, users of conventional generative models, separate of development environments (e.g., word processing applications having tables, spreadsheet programs, etc.) often must spend substantial quantities of time and effort navigating between the generative models and the development environment to generate generative content using the generative models, inserting the generative content into the development environment, and formatting the generative content, etc. However, by optimizing interactions between users, machine-learned large language models, and development environments, implementations of the present disclosure can substantially reduce the time required by users. In turn, this eliminates the expenditure of substantial quantities of computer resources that a user would otherwise use (e.g., compute cycles, power, memory, etc.). Further, by reducing the time expense of users, implementations of the present disclosure can increase efficiency across a number of use-cases (e.g., software engineering, medical research, citing documents for research papers, etc.). Moreover, as personal user data is not provided to the generative model, user privacy is protected. Additionally, as the generative model does not need to populate user information-based fields based on personal user data for each refinement/regeneration, and similarly, as the computing system only needs to populate the user information-based fields based on the personal user data after the generative model has been refined/regenerated, substantial quantities of computer resources (e.g., compute cycles, power, memory, etc.), that would otherwise be used by the generative model and/or computing system, are eliminated.

### Example Methods

FIG. 15 depicts a flow chart diagram of an example method 400 to perform according to example embodiments of the present disclosure. Although FIG. 15 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system provides a user interface to a user computing system. For instance, as discussed above, the user interface can include an integrated development environment (e.g., environment 302) which may be displayed or otherwise provided on the user computing device (e.g., user computing device 102). The integrated development environment can be configured to receive a prompt (e.g., prompt 202). The integrated development environment can be associated with a text-encoding system associated with a set of predetermined symbols associated with a set of formatting operators. For example, the integrated development environment may include any suitable environment configured to allow content within cells, such as a word processor or a spreadsheet program. The integrated development environment may be an online word processor or spreadsheet program, stored or hosted on a server (e.g., server 130) and accessible by a user computing device (e.g., user computing device 102), or may be stored or hosted on a user computing device and have communication with a server. The integrated development environment 302 may allow multiple user computing device(s) 102 to access the general workspace 304 simultaneously to allow for simultaneous or collaborative editing of content within the workspace 104 and generating of content via the generative area(s) 306.

Then, at 404, the computing system receives a prompt including existing content within an integrated development environment from the user computing system via the user interface. For example, as described above, a user may input a prompt within the user interface using one or more input devices of the user computing system (e.g., within the generative area 306 of the integrated development environment 302 using interface component(s) 122 of the user computing system 102) or the prompt may be received passively from the integrated development environment 302. The prompt may include existing content within the integrated development environment (e.g., a title of the integrated development environment, paired and/or unpaired content, and/or the like) and/or processing instructions including a plurality of input characters descriptive of a user prompt request. The plurality of input characters can be descriptive of a natural language text string and/or include one or more syntax symbols. The syntax symbols may be associated with functions of the prompt-generation markup language and/or may be natural language syntax that may denote traditional syntactical use. In some implementations, the plurality of input characters can be descriptive of a plurality of words and/or a plurality of separators (e.g., spaces, commas, periods, slashes, etc.). In some implementations, the prompt may include any other suitable inputs, such as images, and/or the like. In some instances, the existing content is within a first series of content cells (e.g., one or more columns, one or more rows, a title cell, and/or the like) of a grid within the integrated development environment.

Further, at 406, the computing system provides the prompt to a generative model, the generative model being a machine-learned model trained to process language input prompts to generate an output. For instance, as described above, the computing system may provide the prompt to a generative model (e.g., machine-learned model(s) 120, 140) trained to process language input prompts (e.g., natural language prompts having natural language or a combination of natural language and other inputs (e.g., images, etc.)) to generate a language output (e.g., natural language, code, and/or the like). The model may be any suitable model (e.g., a transformer model, a stable diffusion model, an autoregressive language model, and/or the like) trained to process a prompt and generate one or more content outputs.

Moreover, at 408, the computing system receives a generative output generated by the generative model in response to the prompt. For example, as described above, the generative output can include text (e.g., a natural language response, code, etc.), one or more images (e.g., a generated image of the described prompt), an audio file, a video, statistical data, latent encoding data, smart chip data, and/or other signal data responsive to the prompt. Particularly, the generative output may include generative content provided or separated across one or more generative cells. For instance, the one or more generative content cells includes a second series of content cells, the generative content within each of the second series of content cells being associated with the existing content within a respective one of the first series of content cells.

Additionally, at 410, the computing system provides the generative output via the user interface. For instance, as discussed above, the generative output may be provided via the user interface (e.g., via user interface(s) 142). For example, the generative output may be displayed or be otherwise accessible by a user via the interface component(s) 122 of the user computing device 102. In some instances, the generative output may be initially previewed before being inserted in-line within a general workspace (e.g., the general workspace 304) of the integrated development environment. In some instances, generative output (e.g., the second series of cells) replaces at least some of the existing content (e.g., the first series of cells) upon insertion in-line, such as when the generative output comprises smart chips to replace at least some of the existing content. In other instances, the generative output (e.g., the second series of cells) may be provided in addition to the existing content (e.g., the first series of cells) when inserted in-line, such as when the second series includes outputs to be paired with unpaired inputs. As such, content may be generated using a generative model and automatically structured and formatted for insertion within an integrated development environment.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computing system for automatically generating structured content, the computing system comprising:
one or more processors; and
one or more non-transitory computer-readable media that collectively store instructions that, when executed by the one or more processors, cause the computing system to perform operations, the operations comprising:
providing a user interface to a user computing system;
receiving a prompt from the user computing system via the user interface, the prompt comprising existing content within an integrated development environment;
providing the prompt to a generative model, the generative model being a machine-learned model trained to process language input prompts to generate an output;
receiving a generative output generated by the generative model in response to the prompt, the generative output including generative content divided into one or more generative content cells; and
providing the generative output via the user interface.

2. The computing system of claim 1, wherein the existing content is within a first series of content cells of a grid within the integrated development environment, and
wherein the one or more generative content cells comprises a second series of content cells, the generative content within each of the second series of content cells being associated with the existing content within a respective one of the first series of content cells.

3. The computing system of claim 2, wherein the generative content within each of the second series of content cells includes a respective smart chip defined based at least in part on the existing content within the respective one of the first series of content cells.

4. The computing system of claim 3, wherein providing the generative output comprises replacing the first series of content cells with the second series of content cells.

5. The computing system of claim 2, wherein the existing content within the first series of content cells comprises only unpaired inputs.

6. The computing system of claim 1, wherein the prompt further comprises a natural language processing instruction.

7. The computing system of claim 6, wherein the natural language processing instruction requests generating the generative content by at least one of classifying, extracting, summarizing, or standardizing the existing content or suggesting additional content based at least in part on the existing content.

8. The computing system of claim 2, wherein the existing content within the first series of content cells comprises one or more unpaired inputs and at least one pair of input and solution, the generative content within each of the second series of content cells including a respective solution for pairing with the unpaired input within the respective one of the first series of content cells.

9. The computing system of claim 1, wherein providing the generative output comprises providing the generative output in a generative area of the integrated development environment, the generative area separating the generative output from being in-line within the integrated development environment.

10. The computing system of claim 9, the operations further comprising:
receiving an insertion request from the user computing system via the user interface subsequent to providing the generative output; and
inserting the generative output in-line within the integrated development environment in response to receiving the insertion request.

11. The computing system of claim 10, wherein inserting the generative output in-line within the integrated development environment comprises inserting the generative output in-line within the integrated development environment according to formatting rules of the integrated development environment.

12. A computer-implemented method for automatically generating structured content, the method comprising:
providing, by a computing system comprising one or more processors, a user interface to a user computing system;
receiving, by the computing system, a prompt from the user computing system via the user interface, the prompt comprising existing content within an integrated development environment;
providing, by the computing system, the prompt to a generative model, the generative model being a machine-learned model trained to process language input prompts to generate an output;
receiving, by the computing system, a generative output generated by the generative model in response to the prompt, the generative output including generative content divided into one or more generative content cells; and
providing, by the computing system, the generative output via the user interface.

13. The computer-implemented method of claim 12, wherein the existing content is within a first series of content cells of a grid within the integrated development environment, and
wherein the one or more generative content cells comprises a second series of content cells, the generative content within each of the second series of content cells being associated with the existing content within a respective one of the first series of content cells.

14. The computer-implemented method of claim 13, wherein the generative content within each of the second series of content cells includes a respective smart chip defined based at least in part on the existing content within the respective one of the first series of content cells.

15. The computer-implemented method of claim 12, wherein the prompt further comprises a natural language processing instruction.

16. One or more non-transitory computer-readable media that collectively store instructions that, when executed by one or more computing devices, cause the one or more computing devices to perform operations, the operations comprising:
providing a user interface to a user computing system;
receiving a prompt from the user computing system via the user interface, the prompt comprising existing content within an integrated development environment;
providing the prompt to a generative model, the generative model being a machine-learned model trained to process language input prompts to generate an output;
receiving a generative output generated by the generative model in response to the prompt, the generative output including generative content divided into one or more generative content cells; and
providing the generative output via the user interface.

17. The one or more non-transitory computer-readable media of claim 16, wherein the existing content is within a first series of content cells of a grid within the integrated development environment, and
wherein the one or more generative content cells comprises a second series of content cells, the generative content within each of the second series of content cells being associated with the existing content within a respective one of the first series of content cells.

18. The one or more non-transitory computer-readable media of claim 17, wherein the generative content within each of the second series of content cells includes a respective smart chip defined based at least in part on the existing content within the respective one of the first series of content cells.

19. The one or more non-transitory computer-readable media of claim 16, wherein the prompt further comprises a natural language processing instruction.
